(19) United States
(12) Patent Application Publication
(10) Pub. No.: US 2004/0052026 A1
(43) Pub. Date: Mar. 18, 2004

(54) Device for receiving interrupters of circuit breaker systems

(76) Inventors: Wolfgang Opitz, Berlin (DE); Norbert Steinemer, Falkensee (DE)

Correspondence Address: MORRISON & FOERSTER LLP, 1650 TYSONS BOULEVARD, SUITE 300, MCLEAN, VA, 22102, US

(21) Appl. No.: 10/416,335

(22) PCT Filed: Oct. 19, 2001
(86) PCT No.: PCT/DE01/04039

(30) Foreign Application Priority Data
Nov. 9, 2000 (DE) 100 56 646.4

(51) Int. Cl. H01H 73/00

(52) U.S. Cl. 361/115

(57) ABSTRACT

The invention relates to a device for receiving interrupters (SRE) of circuit breaker systems, especially vacuum interrupters for medium-voltage switchgears, comprising a shell-shaped insulating housing (SIG) which envelopes the interrupters (SRE) up to their front side. Said insulating housing (SIG) is provided with rear fixing links for fixing the position. The shell-shaped insulating housing (SIG) is made up of a combination of thin-walled insulating struts (IST), thick-walled bearing struts (TRS) and a support device (SER) which is provided in the rear area. Said housing (SIG) is configured as a single piece and in the top and bottom end areas, is provided with an enveloping contour (UKo, UKu) opening upwards and downwards, respectively. Said contours are configured in such a way that a top and a bottom cooling and fixing fitting (Kat, KAu) of the interrupters (SRE) is received and the interrupters are fixed at the level of the effect of the axial force (EAK) on the shell-shaped insulating housing (SIG). Receiving devices of this type for interrupters are used in conjunction with TRS circuit breaker systems for supplying and distributing energy.

The invention relates to a holding device for interrupters for circuit breaker systems, in particular for vacuum interrupters for medium-voltage switchgear assemblies, having an insulating enclosure in the form of a shell, which surrounds the interrupters except for their front faces, with the insulating enclosure being provided with attachment webs, which are arranged on its rear face, for position fixing.

A holding device for inter rupters (SRE) for circuit breaker systems of the type defined initially is disclosed in patent Specification U.S. Pat. No. 4,449,021. The integral holding device, which is in this case suitable for holding three vacuum interrupters, is used essentially for electrically insulating the interrupters from one another, with the interrupters being entirely surrounded by the insulating walls of the holding device, except for their respective front face. The interrupters are in each case fixed in position on one side by means of a screw attachment in the upper end area of the holding device, while the lower end area of the holding device provides a through-hole for each interrupter, through which the drive for the respective interrupter can be effectively controlled. Furthermore, upper and lower switching contacts are in each case attached by means of screws in the upper end area and in the lower end area of the holding device, for the individual interrupters. The holding device with the three interrupters is a component of a moveable withdrawable carriage, by means of which the switching contacts can be moved to the operating state by moving them into the system, and can be moved to the isolating state by moving them out of the system.

The holding device itself is firmly connected to the withdrawable carrier by means of an insulating frame. The object on which the invention is based is to define the holding device for such interrupters, in particular for vacuum interrupters for medium-voltage switchgear assemblies, such that, in addition to providing an adequate insulation effect, it is also possible for the holding device to absorb without any damage the mechanical loads during the operation of the interrupters in the upper power range of the medium-voltage switchgear assemblies, while ensuring a compact structure, with minimum use of materials in the switchgear assemblies overall, in particular while complying with the electrical and mechanical conditions.

According to the invention, this is achieved by the following features:

1.1 the insulating enclosure which is in the form of a shell is formed from a combination of thin-walled insulating struts, thick-walled supporting struts and a supporting device which is provided in the rearward area,

1.2 the insulating enclosure which is in the form of a shell is formed integrally,

1.3 the insulating enclosure which is in the form of a shell is provided in the upper end area and in the lower end area with a surrounding contour which is open at the top and at the bottom,

1.4 the upper and lower surrounding contours are designed such that an upper and a lower cooling and attachment fitting of the interrupter is held,

1.5 the upper and the lower cooling and attachment fittings of the interrupter are mounted in the plane in which the axial force thereof acts on the insulating enclosure which is in the form of a shell.

The refinement of the insulating enclosure which is in the form of a shell formed by the combination of thin-walled insulating struts and thick-walled supporting struts means that the function of insulation and support for the interrupters is achieved in a compact manner by means of a component which is also used to support the mechanical stresses which occur during switching. The integral configuration of the insulating enclosure takes account of this requirement in a particular manner. At the same time, the surrounding contour, which is open at the top and at the bottom in the upper end area and in the lower end area of the insulating enclosure, provides the capability to in practice mechanically fix the interrupters in position in these areas, at both ends, in the insulating enclosure which is in the form of a shell, and thus to completely absorb the axial forces which occur during switching of the interrupters. The cooling fittings which are provided for these electrical loads are in this case also used in a particularly advantageous manner as attachment fittings for the interrupter.

One advantageous refinement of the invention provides the following features:

2.1 the supporting device of the insulating enclosure which is in the form of a shell tapers in a trapezoidal shape in a rearward extension of the supporting struts,

2.2 the supporting device in each case has an upper and a lower attachment strut.

The trapezoidal taper of the supporting device which is provided in a rearward extension of the supporting struts, with its upper and lower attachment struts, achieves the requirement for a compact physical shape in a simple manner.

A further advantageous refinement of the invention provides the following feature:

3.1 the upper and the lower attachment strut of the insulating enclosure which is in the form of a shell are in the form of in each case two attachment struts which are arranged approximately parallel alongside one another.

This also satisfies the requirements for a greater mechanical load capacity.

A further advantageous refinement of the invention provides the following feature:

4.1 the insulating enclosure which is in the form of a shell is produced from a molded material, preferably from glass-fibre-reinforced polyester resin.

This associates the advantages of low-cost manufacture with adequate electrical insulation.

A further advantageous refinement of the invention is achieved by the feature of

5.1 the insulating enclosure which is in the form of a cell is provided separately for each interrupter.

The mechanical loads during switching are thus limited to the effects caused by one interrupter, so that only one insulating enclosure need be replaced in the event of a fault. At the same time, this allows variable distances between the pole centers of the interrupters, so that creepage currents between the adjacent interrupters are reliably prevented.

The invention will be explained in more detail by means of an exemplary embodiment, which is illustrated in two figures showing the holding device according to the invention for interrupters in the two technical views—in the side view in FIG. 1 and in the plan view in FIG. 2.

FIG. 1 shows a side view of a longitudinal section through the insulating enclosure SIG which is in the form of a shell, in which the interrupter SRE is held with its upper and its lower cooling and attachment fittings KAo and KAu. As can be seen, the insulating enclosure SIG which is in the form of a shell essentially comprises the thin-walled insulating struts IST and the thick-walled supporting struts TRS, which are jointly attached by means of screws by means of the upper and lower attachment struts BSo, BSu in the area of the rear wall RWD of the circuit breaker system, which is not shown in any more detail.

In order to dissipate heat better, the end areas of the insulating enclosure SIG which is in the form of a shell with the upper and lower surrounding contours are open at the top and at the bottom. The horizontally arranged double arrow shows the direction in which the switch drive SAN acts, while the double arrow pointing in the vertical direction shows the operation of the movable contact part, which is not shown, within the interrupter SRE. To assist understanding, the section contours of the insulating enclosure SIG which is in the form of a shell and those of the upper and lower cooling and attachment fittings KAo, KAu are illustrated in a transparent form.

FIG. 2 shows a plan view of the insulating enclosure which is in the form of a shell, with the major components of the thin-walled insulating struts IST, of the thick-walled supporting struts TRS and of the supporting device SER, which tapers in a trapezoidal shape toward the rearward area. The contours of the interrupter SRE, which can be seen only in some areas, are bounded by the upper cooling and attachment fitting KAo. The dashed-dotted lines indicate the detachable screw attachment for the interrupter SRE to the insulating enclosure SIG which is in the form of a shell (FIG. 1), and their screw attachment to the rear wall RWD (FIG. 1), which is likewise shown only in FIG. 1, of the circuit breaker system.

List of Reference Symbols

| | |
|---|---|
| BSo | Upper attachment strut |
| BSu | Lower attachment strut |
| EAK | Plane in which the axial force acts |
| IST | Insulating strut |
| KAo | Upper cooling and attachment fitting |
| KAu | Lower cooling and attachment fitting |
| RWD | Rear wall |
| SAN | Switch drive |
| SER | Supporting device |
| SIG | Insulating enclosure in the form of a shell |
| SRE | Interrupter |
| TRS | Supporting strut |
| UKo | Upper surrounding contour |
| UKu | Lower surrounding contour |

1. A holding device for interrupters (SRE) for circuit breaker systems, in particular for vacuum interrupters for medium-voltage switchgear assemblies, having an insulating enclosure (SIG) in the form of a shell, which surrounds the interrupters (SRE) except for their front faces, with the insulating enclosure (SIG) being provided with attachment webs, which are arranged on its rear face, for position fixing, characterized by the following features
1.1 the insulating enclosure (SIG) which is in the form of a shell is formed from a combination of thin-walled insulating struts (IST), thick-walled supporting struts (TRS) and a supporting device (SER) which is provided in the rearward area,
1.2 the insulating enclosure (SIG) which is in the form of a shell is formed integrally,
1.3 the insulating enclosure (SIG) which is in the form of a shell is provided in the upper end area and in the lower end area with a surrounding contour (UKo, UKu) which is open at the top and at the bottom,
1.4 the upper and lower surrounding contours (UKo, UKu) are designed such that an upper and a lower cooling and attachment fitting (KAo, KAu) of the interrupter (SRE) is held,
1.5 the upper and the lower cooling and attachment fittings (KAo, KAu) of the interrupter (SRE) are mounted in the plane in which the axial force (EAK) thereof acts on the insulating enclosure (SIG) which is in the form of a shell.

2. The holding device for interrupters (SRE) for circuit breaker systems as claimed in claim 1, characterized by the following features:
2.1 the supporting device (SER) of the insulating enclosure (SIG) which is in the form of a she 11 tapers in a trapezoidal shape in a rearward extension of the supporting struts (TRS),
2.2 the supporting device (SER) in each case has an upper and a lower attachment strut (Bso, BSu).

3. The holding device for interrupters (SRE) for circuit breaker systems as claimed in claim 2, characterized by the following feature:
3.1 the upper and the lower attachment strut (BSo, BSu) of the insulating enclosure (SIG) which is in the form of a shell are in the form of in each case two attachment struts which are arranged approximately parallel alongside one another.

4. The holding device for interrupters (SRE) for circuit breaker systems as claimed in one of the preceding patent claims 1 to 3, characterized by the following feature:
4.1 the insulating enclosure (SIG) which is in the form of a shell is produced from a molded material, preferably from glass-fibre-reinforced polyester resin.

5. The holding device for interrupters (SRE) for circuit breaker systems as claimed in one of the preceding patent claims 1 to 4, characterized by the following feature: 5.1 the insulating enclosure (SIG) which is in the form of a shell is provided separately for each interrupter (SRE).
